(19) United States
(12) Patent Application Publication
(10) Pub. No.: US 2024/0409379 A1
(43) Pub. Date: Dec. 12, 2024

(54) TELESCOPIC BOOM LIFT

(71) Applicant: MAGNI REAL ESTATE S.R.L., CASTELFRANCO EMILIA (IT)

(72) Inventor: Riccardo MAGNI, MODENA (IT)

(73) Assignee: MAGNI REAL ESTATE S.R.L., CASTELFRANCO EMILIA (IT)

(21) Appl. No.: 18/701,985

(22) PCT Filed: Oct. 12, 2022
(86) PCT No.: PCT/EP2022/078351

§ 371 Date: Apr. 17, 2024

(30) Foreign Application Priority Data
Oct. 19, 2021 (IT) 102021000026735

(51) Int. Cl. B66F 9/065; B66F 9/075

(52) U.S. Cl. CPC B66F 9/0655; B66F 9/0759

(57) ABSTRACT

A telescopic boom lift, comprising at least:
a vehicle which can move over ground,
a telescopic boom which is supported, directly or indirectly so that it can rotate, by the vehicle and is adapted to support a work accessory,
an element for the actuation of a respective movement of the lift;
   the lift comprises an electronic control and management unit, provided at least with first instructions for the determination, instant by instant, at least of a state of use of the movement actuated by the element, the state being variable between at least two from an enabled state, an inhibited state and an uncontrolled state, and with second instructions, for giving the element a respective color, which corresponds to a state of use thereof and is different from a color that corresponds to another of the states of use.

The present invention relates to a telescopic boom lift.

Telescopic boom lifts are works vehicles which are widespread, since, as is known, they allow to move even bulky loads and accessories, enabling elevated interventions of various kinds, on any terrain and even in the presence of significant environmental constraints.

In the general configuration that is by now established, a telescopic boom lift thus comprises a vehicle which can move over ground and supports a cab defining a cabin designed to receive an operator.

A telescopic boom is articulated directly or indirectly to the vehicle and supports, at the opposite end, a (possibly interchangeable) accessory that enables the lift to carry out the predetermined task.

In some solutions, which make it possible to further increase the versatility of the invention (and, in particular, the working area of the boom), the cab and the boom are mounted on a structure which can rotate about a vertical axis with respect to the vehicle.

Moreover, to ensure adequately firm and safe ground resting, even under particularly demanding load conditions, the lift is often equipped with a stabilizing apparatus, which comprises rotating (and/or telescopic) legs that lift the vehicle off the ground when necessary while extending the resting perimeter.

The control of the various components described so far is entrusted to the operator housed in the cab, who finds all the controls necessary for this purpose in the cabin.

Specifically, in the cabin there is a steering wheel (or joystick), with which the vehicle can be moved, and there is a plurality of buttons, levers, switches, and other control elements of various types, each dedicated to a specific activity or function (telescopic rotation and/or extension of the arm, rotation and/or extension of the legs of the stabilization apparatus, etcetera).

However, this embodiment is not free from drawbacks.

As can easily be deduced, the abundance of functions and activities made available to the operator leads to a multitude of indicators, buttons and controls that the operator himself must be able to recognize and master at all times in order to be able to effectively control the lift (and not jeopardize his own safety with rash maneuvers).

Evidently, this results in numerous difficulties for the operator, who is forced to manage many controls and to recognize promptly, at all times, which maneuvers are permitted or not, precisely to avoid bringing the lift to a dangerous condition.

In the new generation of lifts, efforts have been made to simplify the task for the operator by providing sensors and automatic systems that inhibit the controls that correspond to functions and activities that cannot be performed safely at that time.

Even in this way, however, it is often difficult to control the lift with adequate mastery, since a less trained operator may indeed find that he has attempted an incorrect maneuver only after attempting to operate a temporarily inhibited function, and this is still an unwelcome drawback.

Furthermore, telescopic boom lifts are often equipped with key controls that allow to bypassing the safety systems just described. In such a circumstance, it is evident that the difficulty in mastering the various controls, and thus the possible activation of a function that is not permitted at that time, can have particularly harmful consequences.

The aim of the present invention is to solve the above problems by providing a telescopic boom lift that adopts adequate solutions to make it easier for the operator to control and operate the various functions with which it is equipped.

Within this aim, an object of the invention is to provide a method that makes it easier for the operator to control and operate the various functions with which a telescopic boom lift is equipped.

Another object of the invention is to provide a telescopic boom lift and a method that allow the operator to easily identify the actions that are allowed to him instant by instant.

Another object of the invention is to provide a telescopic boom lift and a method that allow the operator to easily identify the temporary disabling of the safety system.

Another object of the invention is to provide a telescopic boom lift and a method that ensure high reliability of operation.

Another object of the invention is to provide a telescopic boom lift that adopts a technical and structural architecture that is alternative to those of known lifts.

Not least object of the invention is to provide a telescopic boom lift that is easily obtainable starting from commonly commercially available elements and materials.

Yet another object of the invention is to provide a telescopic boom lift and a method that have low costs and are of assured application.

This aim and these and other objects that will become better apparent hereinafter are achieved by a telescopic boom lift according to claim 1 and by a method according to claim 10.

Further characteristics and advantages of the invention will become better apparent from the description of a preferred but not exclusive embodiment of the lift and of the method according to the invention, illustrated by way of non-limiting example in the accompanying drawings, wherein:

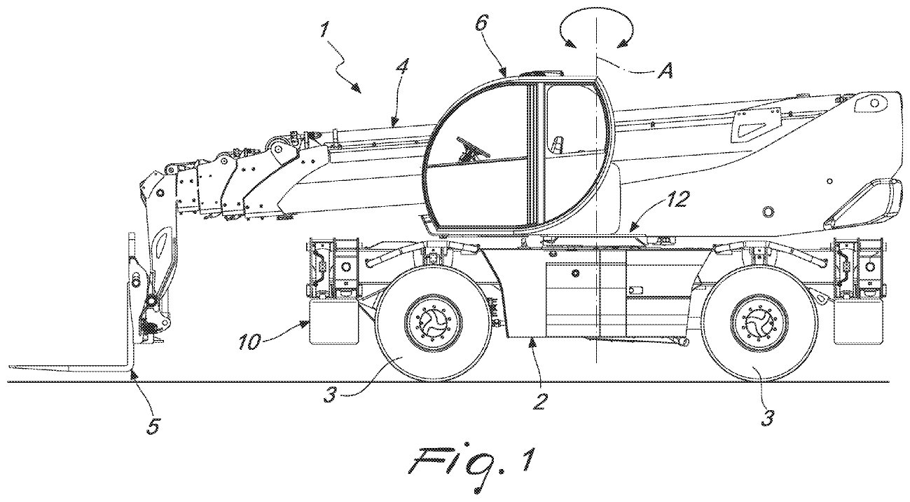

FIG. 1 is a lateral elevation view, in a first operating arrangement, of the telescopic boom lift according to the invention;

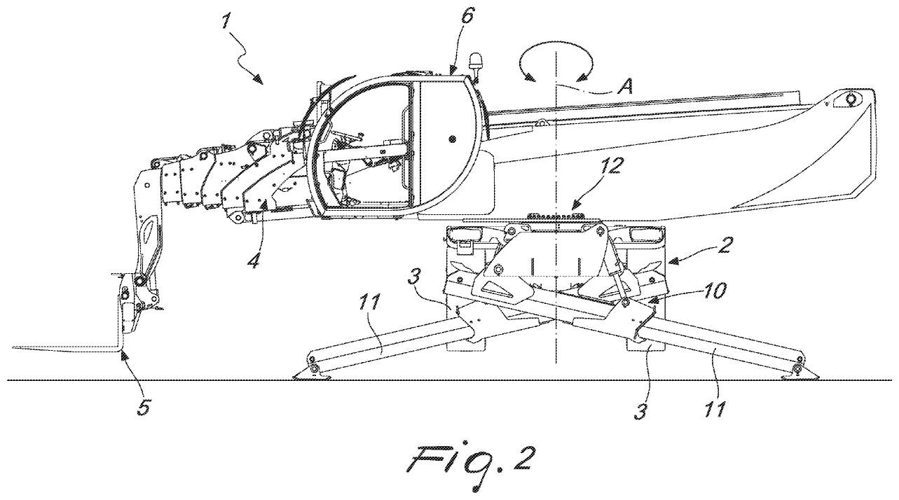

FIG. 2 is a front elevation view, in a second operating arrangement, of the lift of FIG. 1;

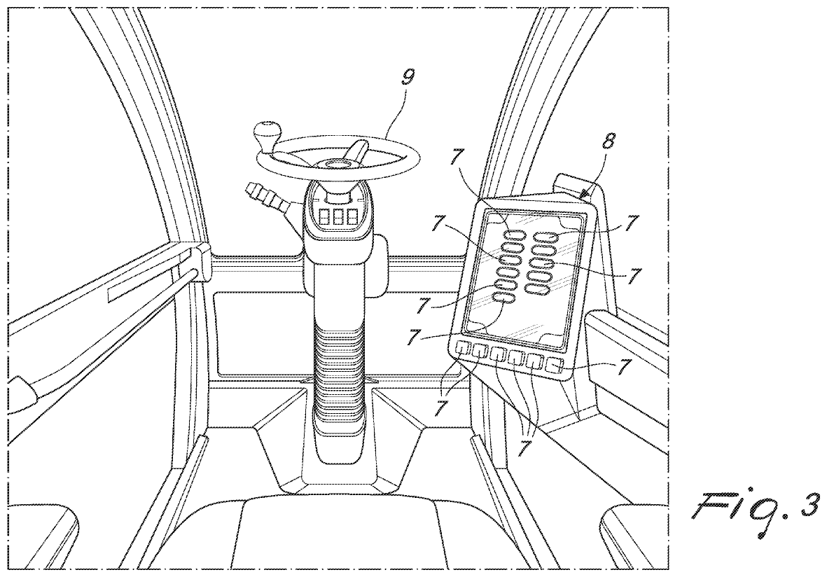

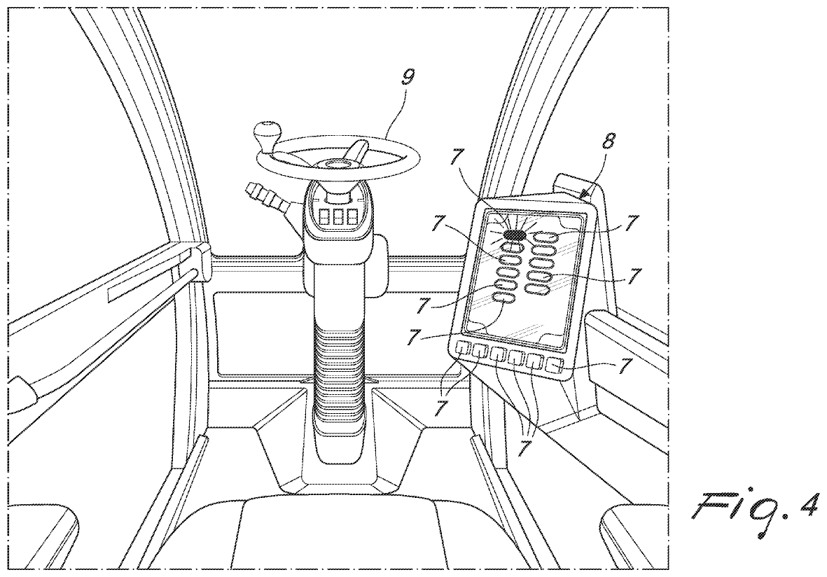

FIGS. 3 and 4 are perspective views of a detail of the interior of a cab of the lift of FIG. 1, with two different colors of one of the actuation elements.

With reference to the figures, the reference numeral 1 generally designates a telescopic boom lift, which comprises, first of all, at least one vehicle 2 (or carriage), which can move over ground (by means of wheels 3 or tracks associated with a suitable traction system).

It should be noted that in the present description the term “boom lift” also comprises all self-propelled works vehicles also known in the field as “telescopic handler” or “telehandler.”

Furthermore, the lift 1 comprises (at least) one telescopic boom 4, which is supported directly or indirectly by the vehicle 2 so that it can rotate and which is adapted to support a work accessory 5. In greater detail, the boom 4 is articulated with a first end to the vehicle 2 directly or indirectly (i.e., with the possible interposition of other components), while oppositely its second end (which is free to move in the surrounding space) is designed to support the accessory 5.

In well-known manners, the telescopic boom 4 is typically composed of a plurality of segments or telescopic elements which are arranged in series and are mutually telescopic (hence the term). In practice, therefore, two possible movements are associated with the boom 4: a rotation (of the entire boom 4) about a horizontal axis of rotation (which is parallel to the ground) which passes through the first end, and a relative translation (extension/retraction) of its telescopic elements, to increase or decrease the overall length of the boom 4 (from one end to the other). However, the possibility that the lift 1 might be equipped with two or more booms 4, which are for example mutually articulated, is not excluded.

The accessory 5 can be of any type: in the figures attached merely by way of example, it has been chosen to show an accessory 5 constituted by a fork, but it could be any other object or tool suitable for the purpose for which use of the lift 1 is intended (it could also be a platform intended to accommodate a person). The accessory 5 (supplied with the lift 1 or procured separately) can also be interchangeable, so that it can be replaced at each intervention, as a function of the specific requirements. The accessory 5 or a set of accessories 5 may thus be comprised within the lift 1, but the protective scope claimed herein also relates to lifts 1 without accessories 5, which are thus sourced separately.

Typically (but not necessarily), the vehicle 2 also supports (directly or indirectly) a cab 6 configured to accommodate an operator.

The lift 1 also comprises (at least) an element 7 for actuating a respective movement of the lift 1. The movement of the lift 1 should be understood as any movement or action or function of any component of the lift 1. For example, an element 7 may be used to actuate the advancement and/or steering of the vehicle 2 (although typically this task is entrusted to a steering wheel 9), an element 7 may be used for the rotation of the boom 4 in one direction or the other and another element may be assigned to the extension or retraction of its segments, an element 7 may open the engine hood, other doors and/or hatches of the cab 6, etcetera. The element 7 may be of the type chosen from a pushbutton, a lever, a switch, a selector, and the like: the element 7 is any device or instrument that indeed allows an operator to actuate any movement or function of the lift 1.

It should be noted in this regard that typically some elements 7 are gathered in a control panel 8. Preferably, the panel 8 and/or the elements 7 are located within the cab 6 so that they can be easily managed by an operator on board, but it is reiterated that the cab 6 may not be present in the lift 1 according to the invention and in any case the panel 8, as well as each element 7 (comprised in the panel 8 or not) can have any placement in the lift 1.

The panel 8 can be entirely or partially digital, be of the touch-screen type or not, and the elements 7 (in the panel 8 or not) can have any shape, size, and appearance (with the particularities that will be described in the pages that follow).

In any case, it is emphasized that for all aspects not covered in detail in the present description, any constructive detail concerning the vehicle 2, the traction devices (of the vehicle 2) and the movement devices (of the boom 4), the cab 6, the accessory 5, the electronic components, and anything else, can be of a known type. Thus, in particular, the person skilled in the art can choose in each instance the setup and embodiment deemed most appropriate, based on the common skills of the sector and according to the specific needs, without, however, abandoning the protective scope claimed herein.

According to the invention, the lift 1 comprises an electronic control and management unit, which is first of all equipped at least with first instructions, in order to be able to determine, instant by instant, at least one state of use of the movement actuated by at least one element 7, said state being variable (even instant by instant, indeed) between at least two from an enabled state, an inhibited state and an uncontrolled state. As mentioned, the movement can be any, and therefore for example one of those mentioned in the preceding pages, one of those that will be described hereinafter, or others still, in any case remaining within the protective scope claimed herein. When the movement is in an enabled state (is enabled), acting on the element 7 (by pressing it or otherwise operating it), said movement is indeed activated, while in the inhibited state nothing happens when acting on the element 7, since other devices of the lift 1 (typically safety devices), even of a known type, have activated indeed to inhibit (prohibit) the movement. Typically, the inhibition is consequent to the detection of a potential hazard or otherwise of insufficient safety conditions associated with the execution of the requested movement; in any case, the reasons leading to the inhibition of movement may be any (and the manners in which the hazardous condition is detected and the manners in which movement is actually inhibited may likewise be any).

The uncontrolled state indicates indeed that, at least at that moment, no control (indeed) of the possibility of safe action is performed: in this case, therefore, by operating the element 7 the movement is performed (as in the enabled state), but (unlike the enabled state) without any guarantee that this will not cause danger or damage (therefore it will be necessary to rely solely on the operator's attention and expertise).

It is also specified that the term “instant by instant” should be understood to mean that the unit continuously checks and updates, in real time, the status of the movement actuated by the element 7, or that in any case it does so with a frequency deemed appropriate to the circumstances.

The protection claimed herein extends to elements 7 for which there are even just two possible states of use and thus only the enabled state and the inhibited state, or only the uncontrolled state and at least one of the other two. Furthermore, of course, all three of those listed above and/or possibly others may be provided for.

Furthermore, according to the invention the electronic unit is equipped at least with second instructions, in order to give the element 7 (whose state of use has been determined) a respective color, which corresponds to its state of use and is different from the one that corresponds to the other states of use. The term “color” is to be understood, equivalently, to mean a partial or total color, a graphical/aesthetic appearance, etcetera, that is in any case capable of allowing the operator who is observing the element 7 to easily recognize, at a glance, one from at least two different states of use of the movement associated with the element 7 (for example, therefore, without having to press it to establish that the corresponding movement is inhibited). The color can be given digitally (if the type of element 7 allows) or by lighting or in some other way, according to the requirements and the reference technology.

Merely by way of example, therefore, one (non-limiting) possibility may be to give the element 7 a green color when the movement is enabled, a red color in case it is inhibited, and a yellow color in the uncontrolled state.

The control and management unit is not shown in the accompanying figures but is typically (but not exclusively) a controller, a PLC, a computer, other hardware, which is reprogrammable or not (for example with a microprocessor); it is usually of a known type (beyond the particularities described here) and is mounted on board the lift 1; typically, it is the same one to which supervision of all the activities of the latter is assigned. However, providing a dedicated electronic unit, to be mounted on the lift 1 and solely assigned to the tasks described here, is not excluded. The functionalities already described (the first instructions and the second instructions), as well as those that will be described hereinafter, with reference to the electronic unit, may be implemented in practice automatically by resorting to the software and/or hardware components that the person skilled in the art would know how to choose, drawing on common industry expertise.

In particular, and as shown by the accompanying FIGS. 3-4, in the preferred embodiment (which in any case does not limit the application of the invention), the lift 1 comprises a plurality of elements 7 (comprised in a panel 8 or not) for actuating respective movements; in this case, therefore, the first instructions implemented in the electronic unit are configured for the respective instant-by-instant determination of the state of use of the movement of each element 7, and the second instructions are configured to give instant by instant each element 7 a respective color, which corresponds to its state of use and is different from the one that corresponds to the other states of use.

Preferably, for all elements 7 the color associated with the enabled state is the same (green for all the elements 7, for example), and so is the color associated with the inhibited state (red for all the elements 7, in case of respective inhibited movements) and the one associated with the absence of movement control; this choice evidently allows to render the operator's use of the invention even more intuitive, but it is not excluded that for particular requirements, one or more elements 7 might adopt different sets of colors than those chosen for other elements 7.

More generally, the lift 1 can be equipped with one or more panels 8, each comprising one or more elements 7.

Any remark that has been made or will be made in the present description in relation to “a” panel 8 or “an” element 7 must therefore be understood to apply to all (or even just some among) the panels 8 or buttons 7 actually present (of whatever type they may be).

Usefully, the lift 1 comprises a safety module, functionally associated with the electronic unit: the module can be an integral part of the electronic unit or can be a separate component that is in any case capable of communicating with the electronic unit. The module can be understood as a hardware and/or software element and/or as a system of mutually cooperating hardware and/or software components.

The safety module is configured to inhibit the movement actuated by the element 7 upon detection of hazardous conditions associated with said movement and/or it is impossible to safely execute said movement.

It has been shown that the first instructions may be intended for the instant-by-instant determination at least of an enabled or inhibited state of the movement actuated by a pushbutton 7: in the preferred embodiment, therefore, such determination provides for an interaction with the safety module or in any case depends on the latter, since the inhibited state is indeed a direct consequence of the action of the safety module. For example, therefore, the module may provide information to the electronic unit and/or the first instructions may provide for a query of the module (and/or of the element 7).

The uncontrolled state may instead correspond to the deactivation of the module (this topic will be discussed again later).

The manners in which the module is able to detect the safety conditions under which the movement that it is designed to (possibly) inhibit would occur may be any.

In particular, the lift 1 may comprise at least one sensor, placed in operative communication with the module (it may also be considered an integral part of the module) and configured to acquire information regarding the possibility of safe execution of the movement actuated by the element 7. Therefore, in this case, the first instructions are configured to determine the enabled or inhibited state based on the information acquired by said sensor. The safety module is thus based on the (at least one) sensor to automatically inhibit the movement actuated by an element 7, if indeed the information acquired from the sensor indicates a potential hazard associated with the movement.

Any number of sensors, of any type and assigned to measure or monitor any quantity, is used to determine indeed the working conditions of the lift 1 (of the component whose movement is to be verified).

For example, therefore, one or more sensors may be assigned to measure the load applied to the accessory 5 and its position relative to the vehicle 2: the module calculates (even in real time) the distribution of the loads and the stresses imposed on the lift 1 and can inhibit the rotation or extension of the boom 4 if it deems that said movements could compromise the stability of the lift 1. In this case, by virtue of the electronic unit, the pushbutton 7 associated with the rotation or extension promptly takes on the color that corresponds to inhibition, in order to inform the operator that said movement is no longer permitted.

The lift 1 can be equipped with a bypass control (key-operated, for example), which can be operated to deactivate at least temporarily the safety module (leaving the operator with full responsibility for control of the lift 1, with the knowledge that the safeties are not active).

Usefully, therefore, the first instructions can be configured to determine the uncontrolled state at module deactivation (or at least the inability to identify the enabled or inhibited state). Said deactivation can be achieved by acting on the bypass control or otherwise.

Usefully, the electronic control and management unit can be equipped with third instructions, to assign an intermittent luminous effect (or in any case any luminous/graphical effect) to at least one element 7 upon determination of the uncontrolled state (the intermittent luminous effect is added to the specific color associated with said state, to make it even more easily recognizable to the eyes of the operator).

The element 7 (a digital pushbutton) in the upper left region in the panel 8 of the accompanying FIGS. 3-4 indeed shows an example of application of the concepts outlined so far: in FIG. 3 it is shown in a first color (common to the other elements 7 as well), which may indeed correspond to the enabled state of the respective movement (of course, it may also be the color related to the inhibited state).

In FIG. 4, instead, the upper left element 7 has taken on a different color and at the same time is flashing (it provides an intermittent light effect), to indicate indeed the uncontrolled state: the safety module has been deactivated and therefore no safety control is active on the corresponding movement (and/or to indicate that it has not been possible to check whether said movement should be enabled or inhibited).

As mentioned, the elements 7 and the corresponding movements for which the functionalities described earlier are provided may be any, without thereby abandoning the protective scope claimed herein. In any case, some examples of specific elements 7 and movements will be listed hereafter, therefore merely by way of non-limiting example.

First of all, therefore, as already anticipated, at least one element 7 can be configured to actuate the extension and/or retraction movement or the rotation movement of the boom 4 (in one direction or the other).

Moreover, the lift 1 may comprise an apparatus 10 for stabilizing the vehicle 2. Such apparatus 10, even of a per se known type, is equipped with telescopic and rotating (usually scissor-like) legs 11 that are movable between a first configuration, with minimum space occupation (FIG. 1) and suitable for road travel, and at least one second configuration (FIG. 2), in which the legs 11 define the ground resting of vehicle 2 (preferably lifting the latter off the ground). The legs 11 allow to extend and widen the ground-resting base of the vehicle 2, and therefore of the lift 1, to ensure greater stability when the accessory 5 is indeed to be moved to perform the task for which it is intended.

If, therefore, the lift 1 is equipped with the apparatus 10, an element 7 can be configured to actuate the extension and/or retraction movement or the rotation movement of the legs 11 (in one direction or the other).

In this case, for example, it should be noted that the rotational movement of the legs 11 is typically to be inhibited when the apparatus 10 is in the minimum space occupation configuration, until at least a partial extension of the telescopic legs 11 (relative translation of its component elements) is performed. This circumstance can indeed be monitored by sensors and managed by the safety module: in any case, when the apparatus 10 is in said situation the electronic unit assign the color (red) associated with the inhibited state to the element 7 assigned to the rotation of the legs 11.

In some embodiments, such as the one in the accompanying figures, the lift 1 is a “rotary” lift 1 and comprises a rotating supporting structure 12 for the boom 4 (and, if provided, for the cab 6), which is supported in a rotating manner by the vehicle 2 (about a vertical axis A, which is perpendicular to the resting surface or to the ground). Obviously, the rotation allows to increase significantly the working area of the accessory 5 and the boom 4, with the vehicle 2 stationary, thereby significantly increasing the versatility of the lift 1: indeed, it should be remembered that the choice where to place the vehicle 2 at the site of operation is often limited by constraints caused by the shape of the ground and/or by other surrounding infrastructure.

If, therefore, the lift 1 is of the rotary type, an element 7 can be configured to actuate the rotational movement of the structure 12 (about the vertical axis A). The safety module can therefore inhibit rotation when, making use of the sensors deemed most appropriate, it has recognized conditions such that the rotation of structure 12 cannot occur safely (for example, because it would cause an imbalance of the lift 1 or because it would cause the boom 4 or cab 6 to collide with walls, trees or other obstacles): in this case, indeed, the element 7 assigned to actuating the rotation of the structure 12 is given the color associated with the inhibited state.

In addition to the lift 1 according to the invention, a method for managing elements 7 for actuating respective movements of telescopic boom lifts 1 is also a subject matter of the protection claimed herein. The lifts 1 on which the method according to the invention is designed to be implemented are of the type illustrated so far and therefore comprise at least one vehicle 2 which can move over ground, a telescopic boom 4 supported directly or indirectly, in a rotatable manner, by the vehicle 2 and suitable to support a work accessory 5, and indeed at least one element 7 for actuating a respective movement of the lift 1.

According to the invention, the method consists at least, in a step a., in determining, instant by instant, at least one state of use of the movement actuated by said element 7, if said state is variable between at least two from an enabled state, an inhibited state, and an uncontrolled state.

Furthermore, the method according to the invention consists, in a step b., in giving said element 7 a respective color that corresponds to its state of use and is different from the color that corresponds to the other states of use.

Steps a. and b. can be performed by an electronic unit of the type already described.

The method may comprise other steps to integrate the functions above described in relation to the telescopic boom lift 1; for example, therefore, a step c. may be provided for assigning an intermittent light effect to at least one element 7 upon the deactivation of the safety module. Furthermore, step b. may also provide for assigning to at least one pushbutton 7 of a third color indeed upon determining the uncontrolled state.

The operation of the telescopic boom lift according to the invention is evident from what has already been described, but a brief summary is given anyway.

In per se traditional manners, the vehicle 2 can move over ground to reach the exact site and point where it is necessary to perform work (usually at a certain height) for which the use of the lift 1 (of the accessory 5 mounted on the boom 4) is indeed required.

In greater detail, after reaching the point of intervention (and possibly activating the apparatus 10, in order to obtain a more stable resting), it is possible to rotate and extend the boom 4 (and optionally the structure 12 with the cab 6), until the accessory 5 is brought to the exact point of intervention.

One or more movements of the lift 1, among those described above or of another kind, are actuated by respective elements 7 comprised or not in one or more panels 8, typically but not necessarily located in the cab 6, where the operator assigned indeed to managing the lift 1 is accommodated.

In a completely innovative and peculiar way, the color of one or more elements 7 is made to vary (automatically, by means of the electronic unit) as the state of use of the corresponding movement changes. The color can be made to vary to indicate that the movement is enabled or inhibited or even if the safety module that is normally in charge of inhibiting movement in case of hazard has been deactivated.

Thus, at a glance and with a quick look, the operator is able to identify and recognize permitted and prohibited maneuvers, without having to try to initiate them to understand them and to ascertain that they are not permitted (as occurs in known embodiments) and without the risk that he acts unaware that the normally (automatically) active controls have been deactivated.

Thus, the lift 1 and the method according to the invention fully achieve the intended aim and objects, since the possibility to vary the color makes it easier for the operator to manage and operate the various functions with which said lift 1 is equipped.

In greater detail, the operator can easily identify the actions that he is allowed to do instant by instant, since they correspond to the elements 7 to which the color associated with the enabled state is assigned (for example green), while, without needing to do so, he knows that pressing or otherwise acting on the pushbuttons 7 in the color associated with the inhibited state will have no effect, since the corresponding movements are currently prevented.

Furthermore, the deactivation of the safety module or in any case the absence of control (and the increased degree of risk associated with the activation of the movement) are signaled with the respective color (and possibly with the intermittent light effect). Therefore, the telescopic lift 1 and the method according to the invention allow the operator to easily identify the temporary disabling of the onboard safety systems.

All the functions of the electronic unit and of the safety module in practice occur automatically, thanks to adequate programming and installation, without requiring personnel intervention.

The invention thus conceived is susceptible of numerous modifications and variations, all of which are within the scope of the appended claims; all the details may furthermore be replaced with other technically equivalent elements.

In the exemplary embodiments shown, individual characteristics, given in relation to specific examples, may actually be interchanged with other different characteristics that exist in other exemplary embodiments.

In practice, the materials used, as well as the dimensions, may be any according to the requirements and the state of the art.

The disclosures in Italian Patent Application No. 102021000026735 from which this application claims priority are incorporated herein by reference.

1.-10. (canceled)

11. A telescopic boom lift, comprising at least:
a vehicle which can move over ground,
a telescopic boom which is supported, directly or indirectly so that it can rotate, by said vehicle and is adapted to support a work accessory,
an element for actuation of a respective movement of said lift, said element being of a type chosen from a button, a lever, a switch, a selector, and the like,
and further comprising an electronic control and management unit, provided at least with first instructions for a determination, instant by instant, at least of a state of use of the movement actuated by said at least one element, said state being variable between at least two from an enabled state, an inhibited state and an uncontrolled state, and with second instructions, for giving said at least one element a respective color, which corresponds to one of said states of use and is different from a color that corresponds to another of said states of use.

12. The telescopic boom lift according to claim 11, further comprising a plurality of said elements for the actuation of respective movements, said first instructions being configured for the respective determination, instant by instant, of the state of use of the movement of each said element, said second instructions being configured to give instant by instant to each said element a respective color, which corresponds to its said state of use and is different from the color that corresponds to the other said states of use.

13. The telescopic boom lift according to claim 11, further comprising a safety module, functionally associated with said electronic unit and configured to inhibit the movement actuated by at least one said element upon detection of dangerous conditions associated with said movement and/or with an impossibility to execute said movement safely.

14. The telescopic boom lift according to claim 13, further comprising at least one sensor, arranged in functional communication with said safety module and configured to acquire information related to a possibility of safe execution of the movement actuated by at least one said element, said first instructions being configured to determine the enabled or inhibited state on the basis of the information acquired by said at least one sensor.

15. The telescopic boom lift according to claim 13, wherein said first instructions are configured to determine said uncontrolled state upon the deactivation of said safety module.

16. The telescopic boom lift according to claim 11, wherein said electronic control and management unit is provided with third instructions for attributing an intermittent luminous effect to at least one said element upon determination of said uncontrolled state.

17. The telescopic boom lift according to claim 11, wherein at least one said element is configured to actuate an extension and/or retraction movement or a rotational movement of said telescopic boom.

18. The telescopic boom lift according to claim 17, further comprising an apparatus for stabilizing said vehicle, which is provided with telescopic and rotating legs, which are configured to move between a first configuration of minimum space occupation and at least one second configuration, in which said telescopic and rotating legs define the ground resting of said vehicle, at least one said element being configured to actuate the extension and/or retraction movement or the rotational movement of said legs.

19. The telescopic boom lift according to claim 11, further comprising a rotating supporting structure for said boom, which is supported rotatably by said vehicle, at least one said element being configured to actuate a rotational movement of said structure.

20. A method for managing actuation elements of respective movements of telescopic boom lifts, said telescopic boom lifts comprising at least one vehicle which can move over the ground, a telescopic boom which is supported, directly or indirectly so that it can rotate, by the vehicle and is adapted to support a work accessory, and at least one said element, wherein the method consists at least in:
a. determining, instant by instant, at least one state of use of a movement actuated by said at least one element, said state being variable between at least two from an enabled state, an inhibited state and an uncontrolled state,
b. giving said at least one element a respective color which corresponds to said state of use thereof and is different from a color that corresponds to another of said states of use.
